(19) United States
(12) Patent Application Publication
(10) Pub. No.: US 2013/0124391 A1
(43) Pub. Date: May 16, 2013

(54) METHOD FOR DISPLAYING MARKET ORDER INFORMATION AND PLACING ORDERS

(71) Applicant: Timothy Wade, Hoddesdon (GB)

(72) Inventor: Timothy Wade, Hoddesdon (GB)

(73) Assignee: FIDESSA PLC, Woking Surrey (GB)

(21) Appl. No.: 13/810,399

(22) PCT Filed: Jul. 18, 2011
(86) PCT No.: PCT/IB2011/002343

§ 371 Date: Jan. 15, 2013

Related U.S. Application Data
(60) Provisional application No. 61/364,955, filed on Jul. 16, 2010.

(51) Int. Cl. G06Q 40/04

(52) U.S. Cl. CPC G06Q 40/04
USPC 705/37

(57) ABSTRACT

Methods of displaying and placing orders for financial instruments. Financial market information is displayed on a screen controlled by a processor. The display includes a plurality of bid columns, a plurality of ask columns, and a price column acting as an axis for the bid and ask columns. Values in the columns are updated as the state of the financial market changes. The values in the columns automatically re-center if either one of the highest bid price, or lowest ask price scrolls off the screen. Placing an order includes presetting order parameters, selecting a price at which to place the order, indicating the price at which to the place the order by indicating a cell associated with a price in a column of a computer display through the use of a computer input device.

### CROSS-REFERENCE TO RELATED APPLICATIONS

This application claims priority from U.S. Provisional Application No. 61/364,955, filed on Jul. 16, 2010, the disclosure of which is incorporated herein by reference in its entirety.

### BACKGROUND

1. Field of the Invention

The present invention generally relates to the electronic trading of financial instruments, or any other form of instrument that can be traded through a market that combines buyers and sellers who place orders to buy and sell (bids and offers) at difference prices for different quantities. The present invention specifically relates to electronic trading of equities, derivatives, swaps, bonds, warrants and currencies. The present invention provides a tool for electronic traders to rapidly and intuitively view and place orders of financial instruments.

2. Description of Related Art.

In the past decade or so, electronic trading of commodities, securities, derivatives, equities and financial instruments in general, have been widely accepted as a common standard. With the advent of the interne, traders have embraced electronic trading as the preferred means to buy and sell items in various market exchanges throughout the world. Traders anywhere in the world equipped with their personal computers can communicate with the computers of the host market exchanges to determine the availability of items and to place and confirm orders.

Traders engaged in electronic trading typically utilize software products that provide them with various specialized graphical user interfaces to obtain market price data, execute orders and monitor status of different market conditions. The overall ease of use and quality of features available to traders depend heavily on the individual type of electronic trading application traders are running.

In electronic trading of financial instruments, the speed at which traders can competitively place an order is of utmost importance. It is absolutely critical that each trader engaged in electronic trading be able to decide instantly whether to wait or fill an order based on the information made available to them through the electronic trading application.

Even a marginal improvement in speed during such process can yield significant returns for traders engaged in electronic trading. On the other hand, a failure to competitively fill an order in a timely manner can potentially result in significant monetary losses accumulated over time. Therefore, competitive advantage in speed is of utmost priority when developing an electronic trading application which enables a trader to engage in electronic trading.

Further, traders engaged in electronic trading must be able to process and absorb numerous market information criteria made available to them while trading. Market exchange is a fast-paced, fluid environment where price, quantity, and other market criteria constantly fluctuate within a very short period of time. The better the organization and representation of information in an electronic trading application is, the more intuitive and easier it becomes for electronic traders to trade. Therefore, in order to provide efficient and accurate placement of orders in an electronic trading environment, it is also imperative that the electronic trading application be intuitive and user-friendly fortraders to use.

### SUMMARY

Exemplary embodiments of the present invention provide a method for displaying financial market information on a screen controlled by a processor, wherein the method includes displaying a plurality of bid columns, displaying a plurality of ask columns, displaying a price column, and updating the values in the columns as the state of the financial market changes. The plurality of bid columns, the plurality of ask columns, and the price column are arranged so that the price column acts a price axis for both the plurality of bid columns and the plurality of ask columns. The updating of the values in the columns includes automatically re-centering the plurality of bid columns, the plurality of ask columns, and the price column if either one of the highest bid price, or lowest ask price scrolls off the screen. The values displayed in the plurality of ask and bid columns include at least one of the volume of lots in the market, the number of the user's orders in the market, and the volume of the user's lots in the market.

Also provided in exemplary embodiments is a method for a user to place orders for an instrument through a computer. The method of placing an order includes the steps of presetting order parameters, selecting a price at which to place the order, indicating the price at which to the place the order by indicating a cell associated with a price in a column of a computer display through the use of a computer input device.

The present invention further provides a method of placing orders for an instrument through a computer that includes receiving order parameters, receiving an input from a user indicating a cell associated with a price in a column of a computer display, and sending an order to a financial market after receiving the indication with the received parameters at the received price.

### BRIEF DESCRIPTION OF THE DRAWINGS

The above and/or other aspects will become apparent and more readily appreciated from the following description of the exemplary embodiments, taken in conjunction with the accompanying drawings, in which:

FIG. 1—A related art display for the display of financial market information.

FIG. 2—A display according to an exemplary embodiment of the present invention.

FIG. 3—A portion of the display depicted in FIG. 2 in which the difference between the best ask and best bid prices is greater than a single tick on the price axis.

FIG. 4—A display according to an exemplary embodiment in which buttons for preset functions are displayed.

FIG. 5—A display for presetting button values.

FIG. 6—A display for presetting “instant” orders.

FIG. 7—A functional block diagram of the steps performed by a user in entering an instant order in an exemplary embodiment of the present invention.

FIG. 8—A functional block diagram of the steps performed by a computer in entering an instant order in an exemplary embodiment of the present invention.

FIG. 9—A functional block diagram of the steps performed by a user in instantly changing an order in an exemplary embodiment of the present invention.

FIG. 10—A functional diagram of the steps performed by a computer in instantly changing an order in an exemplary embodiment of the present invention.

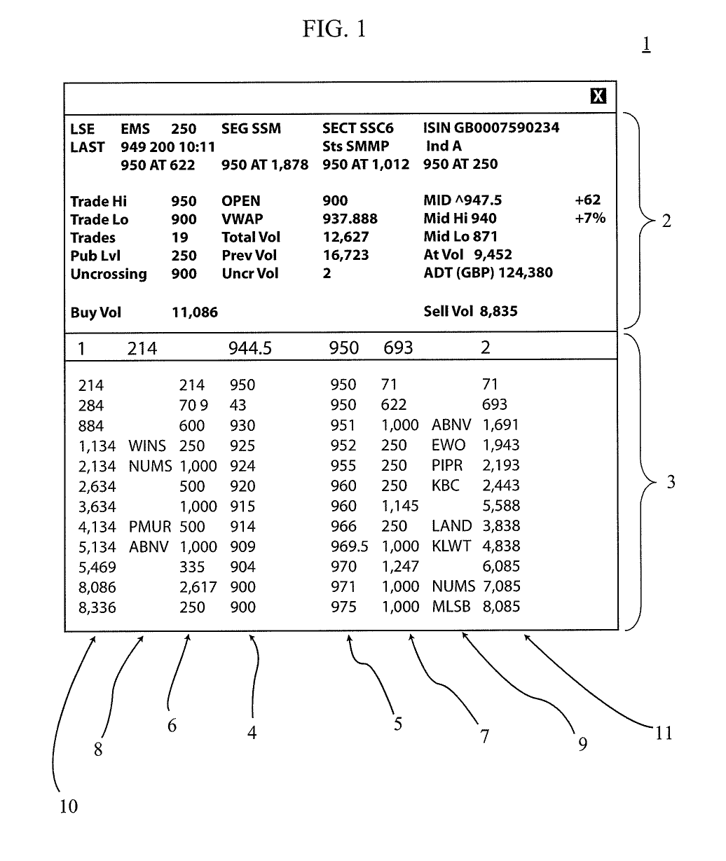

### DETAILED DESCRIPTION OF EXEMPLARY EMBODIMENTS

Below, exemplary embodiments will be described in detail with reference to accompanying drawings so as to be readily understood by a person of ordinary skill in the art. The inventive concept may be embodied in various forms without being limited to the exemplary embodiments set forth herein. Descriptions of well-known parts are omitted for clarity, and like reference numerals refer to like elements throughout.

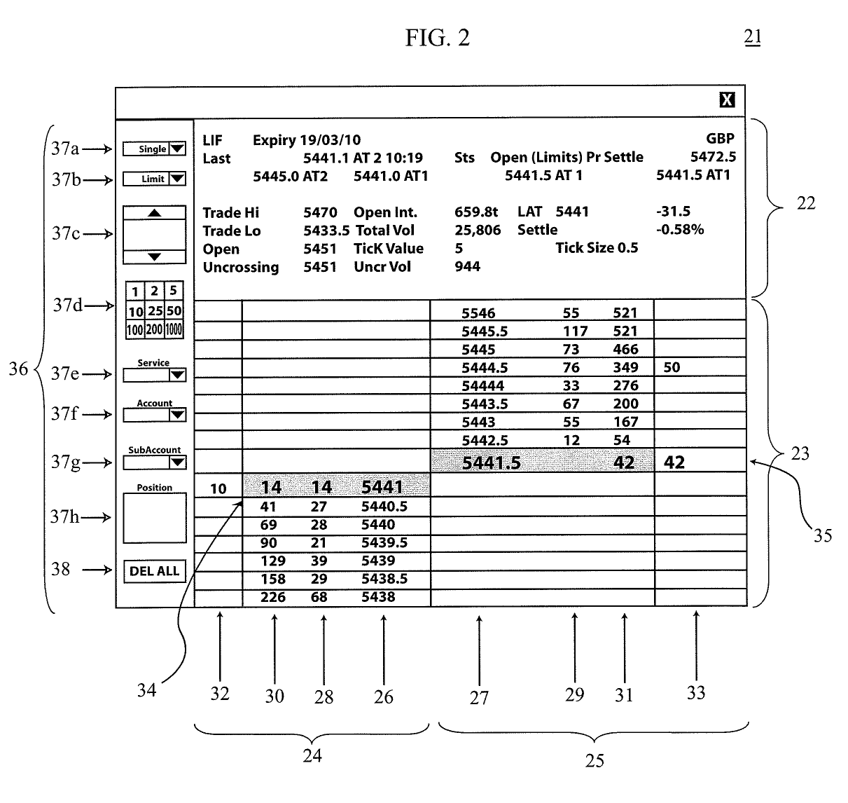

Depicted in FIG. 2 is an exemplary embodiment of the display 21 of the present invention. The display consists of a number of different areas containing financial market information. At the top of display 21 is a market summary section 22. The market summary section 22 includes general market information, and can be customized to contain information specific to a user's preferences. For example, the market summary section 22 can contain information such as the market name, the instrument currently being displayed, the highest and lowest trade values of the day, the total volume being traded, and other values known to those skilled in the art. In addition to information related to the market and the instrument, the market summary section 22 can also display information related to the set-up of the display. For example, the market summary section 22 can display the tick size for the values in the price columns 26 and 27.

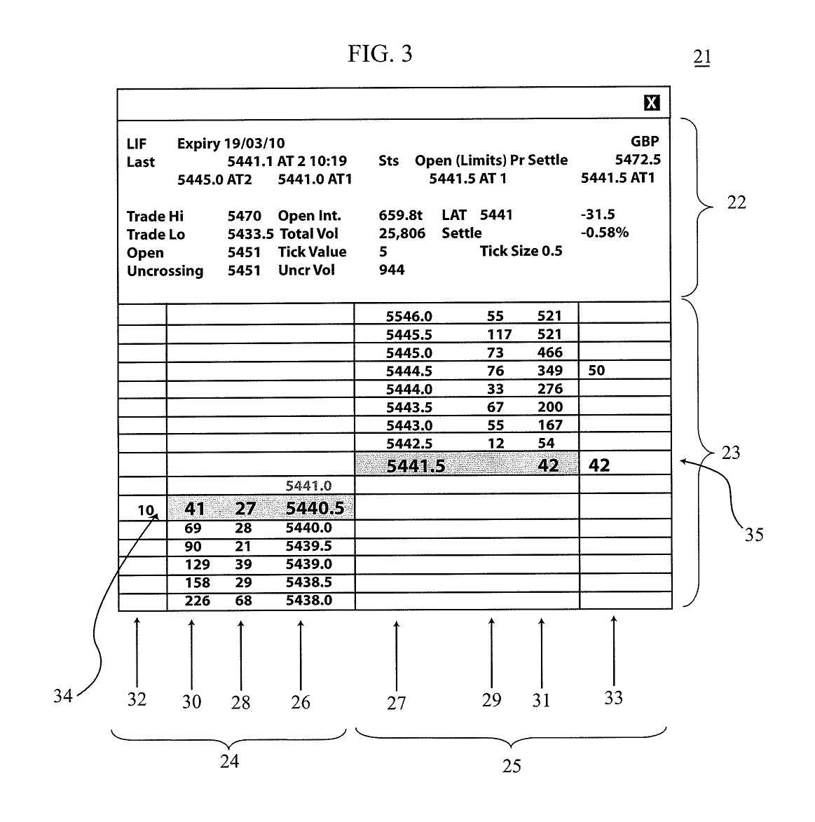

The display 21 also includes order book section 23. Order book section 23 includes a bid section 24 with a plurality of bid columns 26, 28, 30 and 32 and an ask section 25 with a plurality of ask columns 27, 29, 31 and 33. In the exemplary embodiment of FIG. 2, each of the bid section 24 and ask section 25 contain their own price columns 26, 27. In other exemplary embodiments, there can be a single price column. In either case, the rows of the bid section 24 and the ask section 25 are aligned so that a single row across both sections corresponds to a single price. In FIG. 2, the highest bid price and lowest ask price are separated by a single tick in the price scale, but in exemplary embodiments, when the difference between these prices is greater than a single tick, the intervening price values can still be displayed, as depicted in FIG. 3. This allows for benefits which may include the ability to easily place orders between the highest current bid, and lowest current ask prices, as well as allowing the user to see the spread between the highest bid and lowest ask prices. In exemplary embodiments, these prices between the highest bid price and lowest ask price can be displayed in a color different than the colors used to display the other prices. Similarly, the background color of the cells used to display these prices can be different than the background colors of the cells used to display other prices.

In exemplary embodiments, the rows representing the highest bid price and lowest ask price can be highlighted. For example, in FIG. 2 the height of rows 34 and 35, which correspond to the highest bid price and lowest ask price, are taller than the rows corresponding to other prices. In another aspect of exemplary embodiments, the color used to display the highest bid and lowest ask price can be different than the colors used to display the other prices. Similarly, the prices between the highest bid price and lowest ask price can be displayed in a color different from colors used to display the other prices. By highlighting these columns, the user can very quickly determine which prices contain the best bid and ask prices.

The plurality of ask and bid columns can include information that informs the user of the state of the financial market as a whole for the price corresponding to a particular row, as well as information specific to the user of the display. For example, an exemplary embodiment can include a column for the market volume for a particular price, while another column displays the market volume corresponding to the user's orders. Another column may contain the volume of the market at the price associated with a particular row plus the volume of all the higher bids in the case of a bid column, or the volume of all the lower asks in the case of an ask column. Columns containing other values known to those skilled in the art can also be included in the display. Non-limiting examples of the values that may be included in the columns include the last traded price, the high of the day, the low of the day, the inside bid, the inside ask, the total volume traded at a price, and the volume weighted added price. The values displayed in the columns can be chosen by the user based on his or her preferences.

In exemplary embodiments, columns in the ask and bid portions can be displayed such that particular information is highlighted for the user. For example, rows in which the user has placed an order can be highlighted through the use of a color different from that used in displaying other rows. This highlighting can be accomplished by changing the color of the values in the columns, or the color of the background of the rows. Similarly, the change in color can be applied to the individual cell in which the information is displayed, or it can be applied to the entire row containing that information. Information that can be highlighted can include prices at which the user has placed an order, how far a price is from a selected reference price (such as the best ask and prices), prices at which the user has set a trigger for an automatic order, and other types of information that would be known to those skilled in the art. For information such as how far a price is from a selected reference price, the color used to highlight information can gradually change as the values get closer or further from the reference price.

Exemplary embodiments of the present invention can also include instant order setting section 36. This section allows the user to select parameters for the instant order functions to be described below. The instant order type selectors 37A-B allow the user to select the type of order. Once the type of order is selected, instant order selection portions 37C-H allow the user to select the parameters for an instant order. The instant order selection portions 37C-G allow the user to selected parameters for the orders such as the number of lots, the service through which the order will be placed, the account to be used, and the position. Other parameters known to those skilled in the art can also be set in instant order selection section 36. The instant order selection section 36 can also include other elements to help the user enter order parameters. For example, delete key 38 is included to allow the user to quickly and efficiently delete all of the currently entered order parameters.

While FIG. 2 depicts the instant order selection section anchored to the left hand side of display 21, other exemplary embodiments will have the instant order selection section anchored to other portions of the display 21. For example, the instant order selection section could be anchored to the top, bottom, or right side of display 21. Exemplary embodiments also allow for the instant order selection section 36 to be hidden. By hiding instant order selection section 36, the user can save screen space when placing orders, and quickly unhide the instant order selection section when they wish to change the instant order parameters. Other exemplary embodiments include a free floating instant order display described below in relation to FIG. 6.

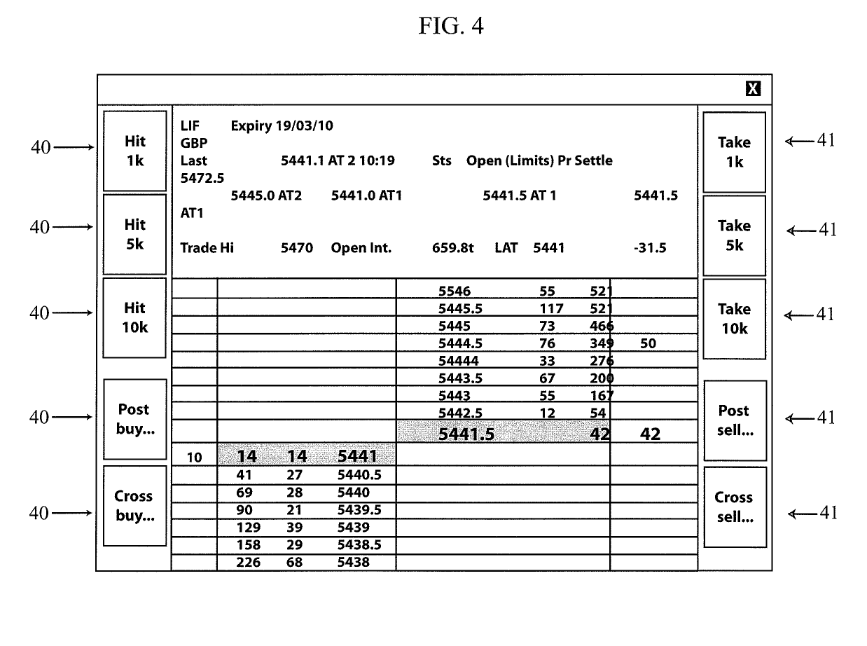

Exemplary embodiments of the present invention can also include other portions of a display. FIG. 4 depicts an exemplary embodiment of the display in which the preset buttons 40A-E and 41A-E are arranged around the edges of the display. The buttons 40A-E and 41A-E can perform functions that are preset by the user. For example, activating a button can create an order for a particular volume of instruments, and it will simply be up to the user to enter the price for the order. Other buttons can be programmed with all of the parameters for an order, including the price. While it may be intuitive for the user to place buttons associated with bid orders near the bid portion of the display, and buttons associated with ask orders near the ask portion of the display, exemplary embodiments are not limited to this type of organization.

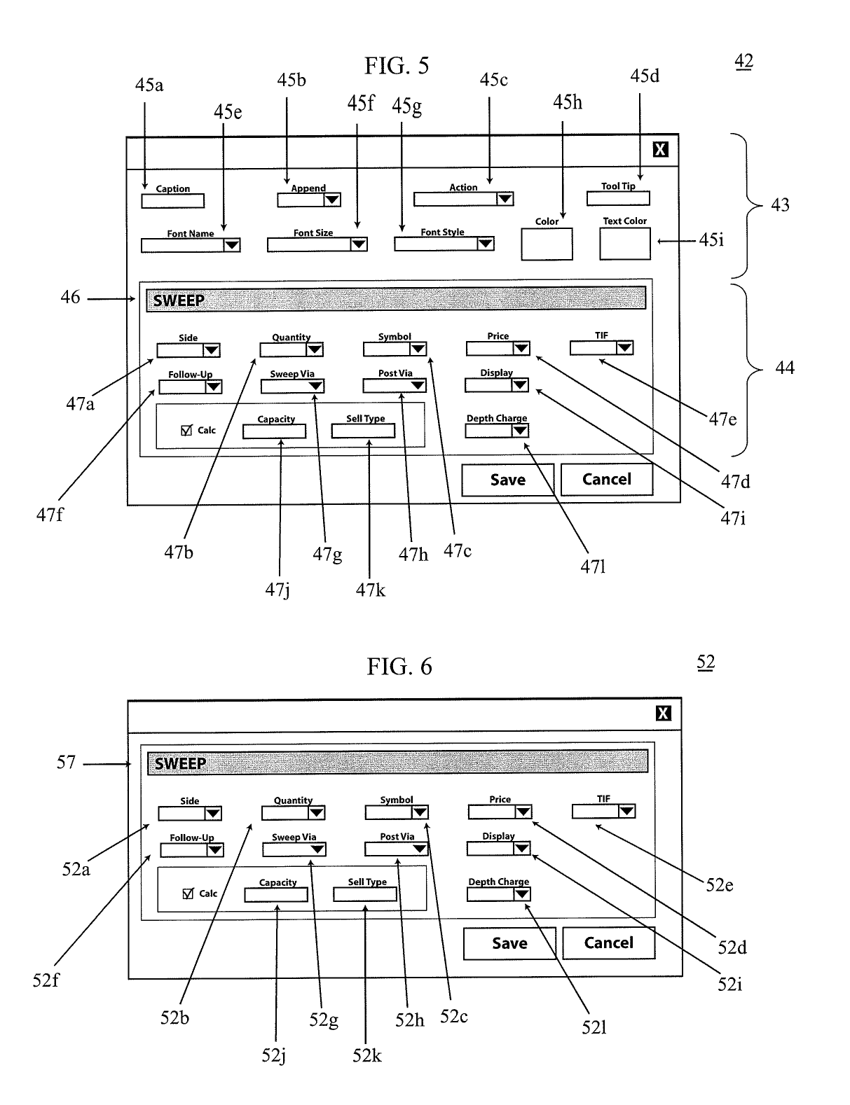

FIG. 5 depicts a button editor display 42 for presetting the buttons described in conjunction with FIG. 4. Button editor display 42 can include two sections: description section 43 and action section 44. Description section 43 includes property selection portions 45A-G which allow the user to control the manner in which the button is displayed, as well as how the user will complete the action to be performed by the button. For example, property selection portion 45A allows the user to give the button a caption, while property selection portion 45F allows the user to select the color of the button. Property selection portion 45B allows the user to select a value to append to the caption of the button, while portion 45C allows the user to set whether a dialog box will open when the button is pressed. Property selection portion 45D allows the user to add to the button a helpful description that would appear, for example, when the user hovers a mouse over the button.

Action section 44 includes an order type selector 46 which allows the user to user to select the type of order or action to be performed by the button. As depicted in FIG. 5, the selected order type is “SWEEP” but other order types known to those skilled in the art can be selected. Once an order type is selected by the order type selector 46, action selection portions 47A-L can be displayed. Some of the action selection portions 47A-L will be specific to the type of order selected by order selector 46, while others may be used no matter which type of order has been selected. Action selection portions 47A-L can allow the user to select whether the order should be a bid or ask, the price at which the order should be made, the vendor used to access the market, how long the order should remain active, and other parameters that would be known to those skilled in the art.

Similar in presentation to button editor display 42, is instant order setting display 50 as depicted in FIG. 6. This display is similar in function to instant order setting section 36, and allows the user to select parameters for the instant order functions to be described below. The instant order type selector 51 allows the user to select the type of order. Once the type of order is selected, instant order selection portions 52A-K are displayed. These portions allow the user to select the parameters for an instant order. The instant order setting display allows the user to select parameters for instant orders by instant order selection portions 52A-K. Instant order selection portion 52A-K are similar to those described above with regards to action selection portions 47 A-L, though some parameters may be included in the instant order selection portions 52A-K that are not contained in action selection portions 47A-L, and vice versa. For example, it will often be unnecessary for there to be an instant order selection portion related to the price of the order due to the manner in which the instant order price is selected, as will be described below.

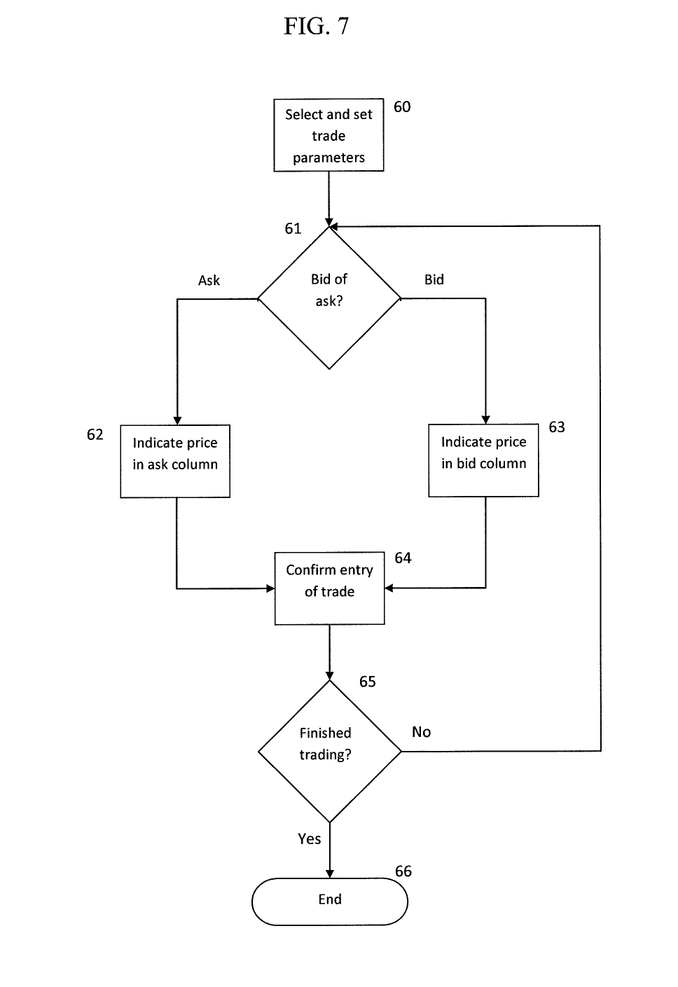

FIG. 7 depicts a functional block diagram of the steps a user would take to perform an instant order in an exemplary embodiment. In functional block 60, the user determines the parameters for the order that will be instantly entered in later portions of the process. This block can include setting values in a display such as those depicted in FIGS. 2 and 6, or it can be as simple as relying on pre-set default values for the instant order. Other methods of setting the order values, known to those skilled in the art, can also be used. In exemplary embodiments, parameters for more than one type of order can be set, and the type of order sent may be determined by the column in which the user selects a price in later parts of the method. For example, parameters specific to a bid order may be sent when the user selects a price in a bid column, while parameters specific to an ask order may be sent when the user selects a price in an ask column.

In functional block 61, the user determines whether the order is an ask or a bid. In other exemplary embodiments, this determination can be made, and set, during the selection of order parameters that takes place in functional block 60.

If the user wants to send an ask order, the processing moves to functional block 62, where a price in the ask column is selected through the use of a computer input device. Similarly, if the user wants to send a bid order, the process moves to functional block 63 where the user selects a price in the bid column through the use of a computer input device. In yet other exemplary embodiments, it may be the case that the user has only pre-set values for one type of order, either an ask or a bid. In this situation, a price can be selected from any column because only one type of instant order can be sent by the system. In other words, if, for example, the user has only pre-set parameters for a bid order, even if the user selects a price in an ask column, a bid instant order will be sent at the selected price.

Once the price has been selected, the user will confirm the entry of the order through use of a computer input device. In exemplary embodiments, this process encompasses confirming the order on the up-click of a mouse button. So, for example, the user would selected a price by clicking the mouse button in either the bid or ask column at a specific price. On the up click of the mouse button, the order is confirmed and the preset parameters are sent to the market. But, if the user changes their mind and decides not to send the order, the user can move the mouse to another portion of the display not associated with a price before allowing the mouse to up-click.

Once the user has made one order, subsequent orders can be made by repeating the process that started at functional block 61. The user would only repeat the steps represented by functional block 60 if they wished to change the preset order parameters.

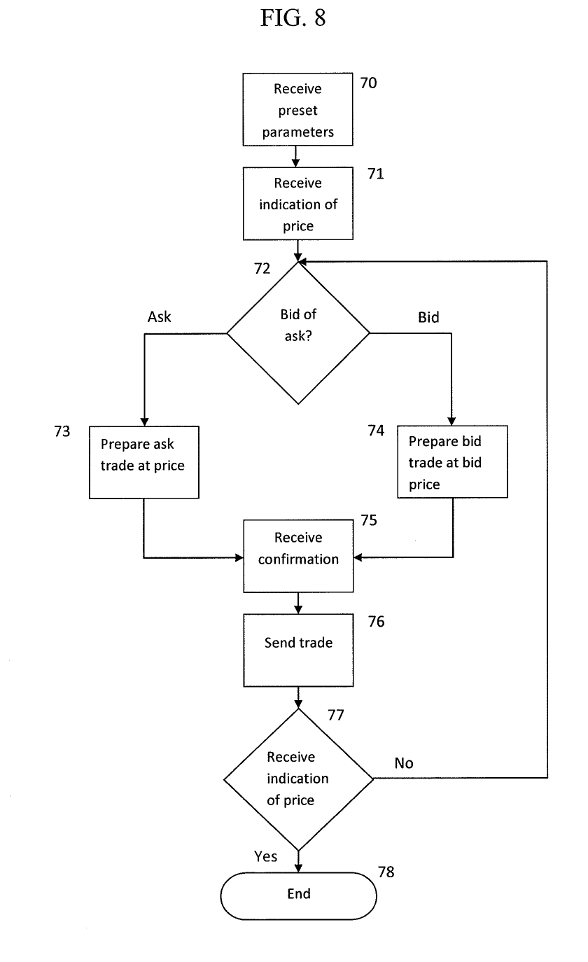

FIG. 8 depicts the steps of a method that would be performed by a computer in receiving and entering order values input by a user. In functional block 70, the computer receives preset order parameters from a user. These parameters are maintained by the computer until the computer receives new preset order parameters.

In functional block 71 the computer receives an indication that a user wishes to make an order through the selection of a price in a bid or ask column of the display. In functional block 72, the computer determines whether the price selected was in the bid or ask column. If the selection was in the bid column, the computer prepares to send the bid with the preset parameters at the indicated price, as depicted in functional block 74. If the price is selected from the ask column , the computer prepares to send an ask order at the price indicated by the selection with the parameters previously received from the user, as depicted in functional block 73. In functional block 75 the order is sent when the computer receives confirmation from the user in the form of an indication from a user input device. For example, in one exemplary embodiment, the user confirms his or her order with the up-click of a mouse button. When the computer receives the indication of the up-click, the computer sends the order.

In other exemplary embodiments, the steps of functional blocks 72-75 can happen in a single step wherein the indication of the of the price, whether the order is a bid or ask, and the confirmation are all received by the computer in a single step.

Once the order has been sent, the computer waits for further indications of new orders or new preset order parameters.

With regards to the steps illustrated in FIGS. 7 and 8, the steps can change as would be known to one skilled in the art. For example, different preset order parameters can be entered and associated to operate with different buttons on a user input device such as a mouse. For example, a bid can be entered with one mouse button, while an ask is entered with a different button. In this instance, the user and computer would not have to determine in which column the price was selected, only the button used to make the indications. Similarly, two sets of parameters, for example different quantities, can be associated with different mouse buttons. In this situation, the preset parameters used to send the order would be different depending on which mouse button is selected by the user, and indicated to the computer.

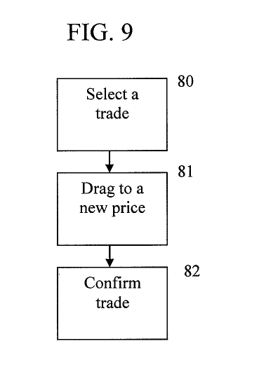

FIG. 9 represents the steps of a method a user would make to change an order according to exemplary embodiments. As depicted in functional block 80, a user would see an order that they entered in the display described above. If for some reason the user wishes to change the price of a particular order, the user would select that order through the use of a user input device. If the device used is a mouse, the user would selected the text or icon indicating their order by clicking the text or icon indicating the order.

In functional block 81, the user indicates the new price for the order by dragging the text or icon indicating the order from the cell in the column representing the old price to a cell in the column representing the new price. This dragging can be accomplished by holding the mouse button after clicking it, and continuing to hold the button as it is dragged. Alternatively, if the system makes use of “click and stick” inputting, clicking the order will “stick” it to the mouse so that it can be dragged without having to hold in the mouse button.

Functional block 82 illustrates how the user will indicate confirmation of their desire to change the price of the order. If the order is dragged by holding in the mouse button, releasing the mouse button at the new order price will confirm the desire to change the order. In a “click and stick” system, a second click of the mouse button would indicate confirmation. In either system, it may be the case that only upon the up-click of the mouse button would the confirmation truly take place.

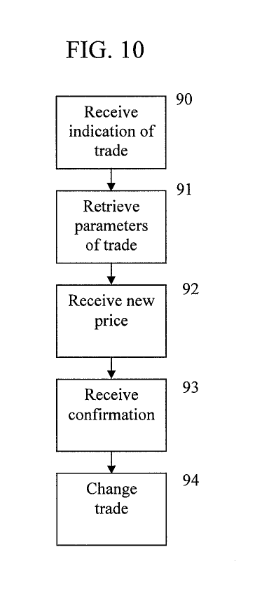

FIG. 10 represents the steps of a method that would be carried out by a computer to change an order according to exemplary embodiments. As illustrated in functional block 90, the computer would first receive an indication of an order that a user wishes to change. This indication could come in the form of an input from a mouse indicating that the text or icon representing an order has been selected.

Functional block 91 illustrates that once the order is clicked, the computer system will retrieve the parameters associated with that order. Once the parameters are retrieved, the computer receives the new price for the order by receiving an indication of such from the user input device, as illustrated in functional block 92. In exemplary embodiments, this indication can come in the form of an input from a mouse indicating that the text or icon associated with the order has been dragged to a new price in the bid or ask columns of the display.

Functional block 93 illustrates that the computer system sends the change in the order to the market based on a confirmation from the user input device. In exemplary embodiments, this confirmation can come in the form of an up-click of a mouse button once the user has completed dragging the order to a new price.

It is also possible that the steps described above can be carried out differently. For example, the indication of the order to be changed, the new price, and the confirmation can all be received at the same time. Then, after receiving these indications, the parameters are retrieved, and the change in the order is sent. It is also possible that the parameters of the order are received at the same time as the indications.

While the following has particularly shown and described exemplary embodiments, it will be understood by those of ordinary skill in the art that various changes may be made therein without departing from the spirit and scope of the present invention as defined by the following claims.

What is claimed is:

1. A method of displaying financial market information on a screen controlled by a processor, comprising:
displaying a plurality of bid columns,
displaying a plurality of ask columns,
displaying a price column,
updating the values in the columns as the financial market changes,
automatically re-centering the plurality of bid columns, the plurality of ask columns, and the price column if either one of the highest bid price or lowest ask price scrolls off the screen,
wherein the plurality of bid columns, the plurality of ask columns and the price column are arranged so that the price column acts as a price axis for both the plurality of bid columns and the plurality of ask columns;
wherein the plurality of bid columns display at least one of the volume of lots in the market, the number of the user's orders in the market, and the volume of the user's lots in the market,

2. The method according to claim 1, wherein the row in the plurality of bid columns representing the highest bid price are larger than the rows corresponding to the other prices;
wherein the row in the plurality of ask columns representing the lowest ask price is larger than the rows corresponding to the other ask prices;
wherein when the highest bid price changes, the updating further comprises making the size of the row of the previous highest bid price the same size as the rows corresponding to the other prices, and making the row corresponding to the new highest bid price larger than the rows corresponding to the other prices; and
wherein when the lowest ask price changes, the updating further comprises making the size of the row of the previous lowest ask price the same size as the rows corresponding to the other prices, and making the row corresponding to the new lowest ask price larger than the rows corresponding to the other prices.

3. The method according to clam 2, wherein the prices of the highest bid price and lowest ask price are displayed in a color different than the colors used to display the other prices.

4. The method according to claim 2 ,wherein the prices higher than the highest bid price and lower than the lowest ask price are displayed in a color different than the colors used to display the other prices.

5. The method according to claim 2 wherein the rows corresponding to prices where the user currently has orders are displayed in a color different than the rows corresponding to prices where the user does not have any orders.

6. The method according to claim 2, wherein a column representing the volume of the user is displayed in a color different than the colors used to display the values in the other columns.

7. The method according to claim 2 where a column representing the number of orders of the user is displayed in a color different than the colors used to display the values in the other columns.

8. The method according to claim 2, wherein a column representing the market volume is displayed in a color different than the colors used to display the values in the other columns.

9. The method according to claim 2, wherein the color used to display the price in the price column changes with the volume of the market at that price.

10. The method according to claim 2, wherein the plurality of bid and ask columns include columns for displaying at least one of a number of orders and a volume of orders in different columns for different customers of the user.

11. The method according to claim 2, wherein the columns are displayed vertically.

12. The method according to claim 2, wherein the columns are displayed horizontally.

13. The method according to claim 2, further comprising displaying an order parameters window displaying default values for orders entered by the user.

14. The method according to claim 13, further comprising hiding the order parameters window when the user does not need to enter or view order parameters.

15. The method according to claim 2, wherein the background color of the rows changes as the difference between the price associated with the rows becomes higher than the lowest ask price, or lower than the highest bid price.

16. A method of placing an order for a security through a computer, comprising:
using a computer input device to select a value in the price column,
selecting order parameters in an order window;
confirming the order parameters through use of the computer input device.

17. A method of placing an order for a security through a computer, comprising:
presetting order parameters;
associating the preset order parameters with a button to be displayed on a screen;
activating the button on the screen through the use of a computer input device;
confirming the order through use of a computer input device.

18. The method according to claim 17, further comprising:
after activating the button, selecting a price at which to place the order.

19. A method for a user to place orders for a security through a computer, comprising:
presetting order parameters;
selecting a price at which to place the order;
indicating the price at which to the place the order by indicating a cell associated with a price in a column of a computer display through the use of a computer input device.

20. The method according to claim 19, further comprising:
repeating the steps of selecting and indicating until the user desires to change the order parameters.

21. The method according to claim 20, wherein the step of indicating comprises indicating a cell associated with a price in a bid column when the user wishes to indicate a bid order.

22. The method according to claim 21, wherein the step of indicating comprises indicating a cell associated with a price in an ask column when the user wishes to indicate an ask order.

23. The method according to claim 22, wherein the step of presetting order parameters comprises setting ask order parameters and bid order parameters.

24. The method according to claim 23, wherein the step of presetting order parameters comprises setting ask order parameters and bid order parameters that are different from each other.

25. The method according to claim 24, wherein the step of indicating further comprises indicating a customer by indicating a price in a column associated with the customer.

26. The method according to claim 25, wherein the step of presetting further comprises entering order parameters in an order parameter window.

27. The method according to claim 26, wherein the step of presetting further comprises hiding the order parameter window.

28. A method of placing an order for a security through a computer, comprising:
receiving order parameters;
receiving an order from a user input indicating a cell associated with a price in a column of a computer display;
sending an order to a financial market after receiving the indication with the received parameters and at the received price.

29. The method according to claim 28, further comprising:
repeating the steps of receiving an order and sending orders until new order parameters are received.

30. The method according to claim 29, wherein the step of receiving an order comprises receiving a bid order at a price by an indication of a cell associated with a price in a bid column of a computer display.

31. The method according to claim 30, wherein the step of receiving an order comprises receiving an ask order at a price by an indication of a cell associated with a price in an ask column of a computer display.

32. The method according to claim 31, wherein the step of receiving order parameters further comprises receiving ask order parameters and bid order parameters.

33. The method according to claim 32, wherein the step of receiving order parameters further comprises receiving ask order parameters and bid order parameters that are different from each other.

34. The method according to claim 33, wherein the step of receiving an order further comprises receiving an order for a customer by receiving an indication of a cell associated with a price in a column associated with the customer.

35. The method according to claim 34, wherein the step of receiving order parameters further comprises receiving order parameters from entries in fields in an order parameters window.

36. The method according to claim 35, wherein the step of receiving order parameters further comprises hiding the order parameter window after the parameters have been received from the fields.

37. The method according to claim 36, wherein the step of sending the order after receiving an indication of an up-click of a user's mouse.
